(19) United States
(12) Patent Application Publication
(10) Pub. No.: US 2009/0061401 A1
(43) Pub. Date: Mar. 5, 2009

(54) Apparatus to enhance enjoyment from reading printed subject matter

(76) Inventors: Debra Fleming, Santee, CA (US); Dane Fleming, Santee, CA (US)

Correspondence Address: JAMES RAY & ASSOCIATES, 2640 PITCAIRN ROAD, MONROEVILLE, PA, 15146, US

(21) Appl. No.: 12/229,692

(22) Filed: Aug. 26, 2008

Related U.S. Application Data
(60) Provisional application No. 60/966,923, filed on Aug. 30, 2007.

(51) Int. Cl. G09B 17/00

(52) U.S. Cl. 434/178

(57) ABSTRACT

A handheld apparatus to enhance reading enjoyment of printed subject matter includes a housing member having a predetermined shape and a predetermined size. A micro-processing unit is disposed in the housing member. There is a power source disposed within the housing member. Such power source is connected to the micro-processing unit. A program containing at least a dictionary therein is disposed in the micro-processing unit. Additionally, there is a scanner disposed in the housing member that is in electrical communication with the power source and the micro-processing unit for scanning a printed word. Finally, there is a display screen disposed on a predetermined face of the housing member and in electrical communication with the power source and the micro-processing unit for displaying a definition of a scanned word.

### CROSS REFERENCE TO RELATED APPLICATION

This patent application is related to and claims priority from U.S. Provisional Patent Application Ser. No. 60/966,923 filed Aug. 30, 2007 and incorporated herein by reference thereto.

### FIELD OF THE INVENTION

The present invention relates, in general, to reading printed subject matter and, more particularly, this invention relates to an apparatus which will enhance a reader's enjoyment while reading such printed subject matter.

### BACKGROUND OF THE INVENTION

Prior to the conception and development of the present invention, as is generally well known in the prior art, Americans have ranked well below average in literacy over the past several years.

This fact is all evidenced by the decline in test scores, reading comprehension as well as a significant decline in book sales. It is further believed that book reading has been replaced primarily by television and movies as well as computer surfing and video games.

Additionally and of even more importance, it is felt that many people do no read because they have difficulty in understanding certain words. This normally will result in not understanding sentences and thus leading to a generally unpleasant reading experience. As a result, oftentimes the entire meaning of an important aspect of the subject matter being read may be lost.

Even though there are a number of ways to find definitions and how to pronounce a word, such as dictionaries and computers, these items may not always be handy when the person is reading or studying.

### SUMMARY OF THE INVENTION

The present invention provides a handheld apparatus to enhance reading enjoyment of printed subject matter. The apparatus includes a housing member having a predetermined shape and a predetermined size. A micro-processing unit is disposed in the housing member. Further there is a power source also disposed within the housing member. Such power source is connected to the micro-processing unit. There is a program containing at least a dictionary therein disposed in the micro-processing unit. A scanner is disposed in the housing member and in electrical communication with the power source and the micro-processing unit for scanning a printed word to be defined. The final essential element of the handheld apparatus to enhance reading enjoyment is a display screen disposed on a predetermined face of the housing member and in electrical communication with the power source and the micro-processing unit for displaying the definition of a scanned word.

### OBJECTS OF THE INVENTION

It is, therefore, one of the primary objects of the present invention to provide an apparatus which will enhance enjoyment from reading printed subject matter.

Another object of the present invention is to provide an apparatus to enhance reading enjoyment which is both relatively easy and fun to use.

Still another object of the present invention is to provide an apparatus to enhance reading enjoyment which is portable.

Yet another object of the present invention is to provide an apparatus to enhance reading enjoyment which will improve reading comprehension.

An additional object of the present invention is to provide an apparatus to enhance reading enjoyment which in addition to a printed definition of a word such apparatus will also be capable of providing an audible definition.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a front view of a presently preferred embodiment of the housing portion of the invention illustrating a touch screen disposed on the face thereof;

FIG. 2 is a side view of the housing member illustrated in FIG. 1 showing a location of a plurality of buttons and an on off switch;

FIG. 3 is a back view of the housing member illustrated in FIGS. 1 and 2 illustrating openings in the housing member for allowing sound to be emitted from a speaker disposed in the housing; and

FIG. 4 is a schematic diagram of the various components of the electronics portion of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

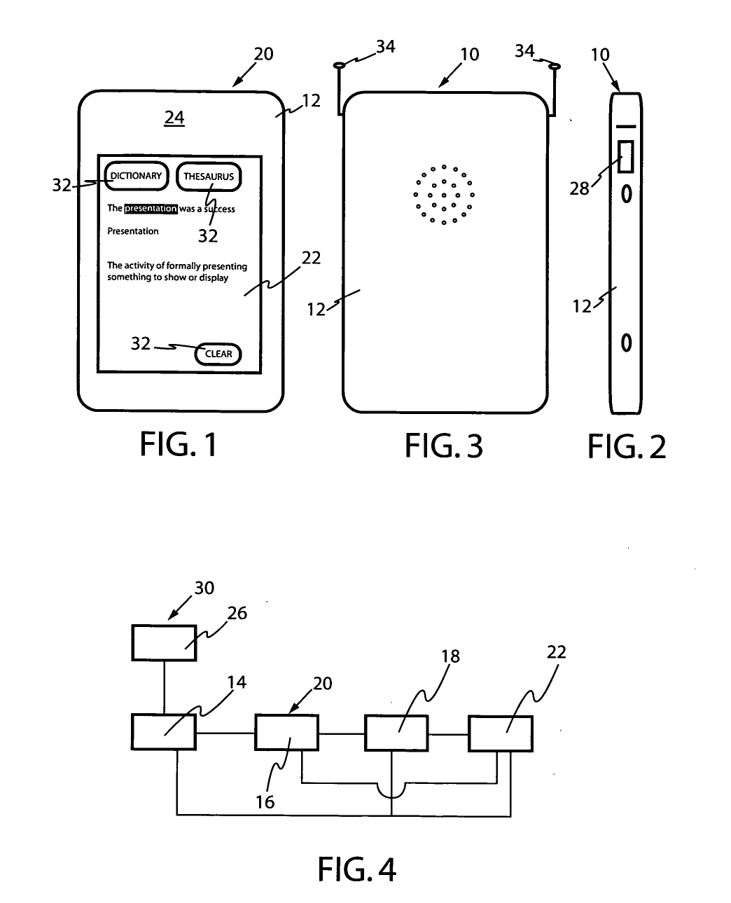

Reference is now made, more particularly, to drawing FIGS. 1-4. Illustrated therein is a presently preferred embodiment of a handheld apparatus, generally designated 10, to enhance reading enjoyment of printed subject matter by a user of the apparatus 10.

The apparatus 10 includes a housing member 12 having each of a predetermined shape and a predetermined size. In the presently preferred embodiment of the invention, the predetermined shape of the housing member 12 will be a generally rectangular shape. The predetermined size of such housing member 12 will generally be between about 2.0 to 3.0 inches wide and between about 4.0 and 5.0 inches long and between about 0.5 and 0.75 inch thick.

There is a micro-processing unit 14, having a predetermined memory, disposed within the housing member 12. There is a program containing at least a dictionary therein disposed in the micro-processing unit 14 and the predetermined memory will, preferably, be at least sufficiently large to hold a college dictionary therein in addition to a plurality of predetermined programs. Such predetermined programs will include functions that are selected from the group consisting of dictionary, thesaurus, synonyms, voice activation, scanner, scroll and clear.

The apparatus 10 further includes a power source, generally designated 20, disposed one of within and outside the housing member 12 and electrically connected to the micro-processing unit 14. In the present invention the power source 20 is one AC (not shown) and DC battery power 16. It is presently preferred that the power source 20 is the battery 16 and that battery 16 is a rechargeable battery. It is further within the scope of the present invention to be able to use a car battery.

A scanner 18 is disposed in the housing member 12 and is in electrical communication with the power source 20 and the micro-processing unit 14 for scanning a printed word.

The final essential element of the invention is a display screen 22, preferably a touch screen 22, disposed on preferably a front face 24 of the housing member 12 and in electrical communication with power source 20 and the micro-processing unit 14 for displaying a definition of a scanned word.

Apparatus 10 will, preferably, further include a means, generally designated 30, that is connected to the micro-processing unit 14 for verbalizing the definition of a scanned word. Such means 30 is preferably a speaker 26.

Apparatus 10 further includes a switch means 28 connected between said power source 20 and each of the micro-processing unit 14, the scanner 18 and the display screen 22 for turning apparatus 10 on and off.

The touch screen 22 includes a predetermined plurality of touch locations 32 relating to a plurality of functions to be preformed by apparatus 10. Such predetermined plurality of functions at least include a dictionary and clear.

Finally, in the presently preferred embodiment of the invention apparatus 10 also includes a pair of scanning lights 34 to accommodate both left and right handed users.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. A handheld apparatus to enhance reading enjoyment of printed subject matter, said apparatus comprising:
(a) a housing member having each of a predetermined shape and a predetermined size;
(b) a micro-processing unit, having a predetermined memory, disposed within said housing member;
(c) a power source disposed within said housing member and electrically connected to said micro-processing unit;
(d) a program containing at least a dictionary therein disposed in said micro-processing unit;
(e) a scanner disposed in said housing member and in electrical communication with said power source and said micro-processing unit for scanning a printed word; and
(f) a display screen disposed on a predetermined face of said housing member and in electrical communication with said power source and said micro-processing unit for displaying a definition of a scanned word.

2. An apparatus, according to claim 1, wherein said predetermined shape of said housing member is generally rectangular.

3. An apparatus, according to claim 1, wherein said predetermined size of said housing member is generally between about 2.0 to 3.0 inches wide and between about 4.0 and 5.0 inches long and between about 0.5 and 0.75 inch thick.

4. An apparatus, according to claim 1, wherein said power source is one AC, DC and battery power.

5. An apparatus, according to claim 4, wherein said power source is a battery.

6. An apparatus, according to claim 5, wherein said battery is one of a rechargeable battery and a car battery.

7. An apparatus, according to claim 6, wherein said battery is a rechargeable battery.

8. An apparatus, according to claim 1, wherein said apparatus further includes a means connected to said micro-processing unit for verbalizing said definition of a scanned word.

9. An apparatus, according to claim 8, wherein said apparatus further includes a speaker connected to said micro-processing unit.

10. An apparatus, according to claim 1, wherein said micro-processing unit further includes a thesaurus disposed therein.

11. An apparatus, according to claim 1, wherein said apparatus further includes a switch means connected between said power source and each of said micro-processing unit, said scanner and said display screen for turning said apparatus on and off.

12. An apparatus, according to claim 1, wherein said display screen is a touch screen.

13. An apparatus, according to claim 12, wherein said touch screen includes a predetermined plurality of touch locations relating to a plurality of functions to be preformed by said apparatus.

14. An apparatus, according to claim 13, wherein said predetermined plurality of functions are selected from the group consisting of dictionary, thesaurus, synonyms, voice activation, scanner, scroll and clear.

15. An apparatus, according to claim 15, wherein said predetermined plurality of functions at least include a dictionary and clear.

16. An apparatus, according to claim 1, wherein said apparatus further includes a pair of scanning lights to accommodate both left and right handed users.

17. An apparatus, according to claim 1, wherein said predetermined memory of said micro-processing unit is at least sufficient to hold a college dictionary therein.
